(19) United States
(12) Patent Application Publication
(10) Pub. No.: US 2023/0372917 A1
(43) Pub. Date: Nov. 23, 2023

(54) EXHAUST GAS PURIFICATION DEVICE AND METHOD FOR MANUFACTURING EXHAUST GAS PURIFICATION DEVICE

(71) Applicants: Takahiro NISHIO, Miyoshi-shi (JP); Shogo Shirakawa, Toyota-shi (JP); Hiroki Shirakawa, Toyota-shi (JP); Nobuyuki Takagi, Toyota-shi (JP); Tomomasa Aikawa, Fukuroi-shi (JP); Hiroki Nihashi, Hamamatsu-shi (JP); Takahiro Noguchi, Hamamatsu-shi (JP)

(72) Inventors: Takahiro NISHIO, Miyoshi-shi (JP); Shogo Shirakawa, Toyota-shi (JP); Hiroki Shirakawa, Toyota-shi (JP); Nobuyuki Takagi, Toyota-shi (JP); Tomomasa Aikawa, Fukuroi-shi (JP); Hiroki Nihashi, Hamamatsu-shi (JP); Takahiro Noguchi, Hamamatsu-shi (JP)

(73) Assignees: TOYOTA JIDOSHA KABUSHIKI KAISHA, Toyota-shi (JP); CATALER CORPORATION, Kakegawa-shi (JP)

(21) Appl. No.: 18/318,238

(22) Filed: May 16, 2023

(30) Foreign Application Priority Data
May 23, 2022 (JP) 2022-083649

(51) Int. Cl. B01J 35/00; B01J 23/46; B01J 23/58; B01J 23/10; B01J 37/02; B01J 37/08; B01D 53/94; F01N 3/28

(52) U.S. Cl. CPC B01J 35/0006; B01J 35/0013; B01J 35/006; B01J 23/464; B01J 23/58; B01J 23/10; B01J 37/0201; B01J 37/0215; B01J 37/0236; B01J 37/0248; B01J 37/088; B01D 53/9472; F01N 3/2825; B01D 2255/1025; B01D 2255/1023; B01D 2255/9202; B01D 2255/2042; B01D 2255/908; B01D 2257/404; B01D 2255/407; B01D 2255/20715; B01D 2255/2065; B01D 2257/702; B01D 2258/01; F01N 2370/02; F01N 2510/068

(57) ABSTRACT

The exhaust gas purification device includes: a substrate including an upstream end through which an exhaust gas is introduced and a downstream end through which the exhaust gas is discharged; a first catalyst layer containing a rhodium-containing catalyst containing a metal oxide carrier and rhodium particles supported on the metal oxide carrier, the first catalyst layer extending across a first region; and a second catalyst layer containing palladium particles and a material having a basicity higher than a basicity of the metal oxide carrier, the second catalyst layer extending across a second region. A mean of a particle size distribution of the rhodium particles is from 1.5 nm to 18 nm.

### CROSS REFERENCE TO RELATED APPLICATIONS

The present application claims priority from Japanese patent application JP 2022-083649 filed on May 23, 2022, the entire content of which is hereby incorporated by reference into this application.

### BACKGROUND

### Technical Field

The present disclosure relates to an exhaust gas purification device and a method for manufacturing the exhaust gas purification device.

### Background Art

An exhaust gas discharged from an internal combustion engine used in a vehicle, such as an automobile, contains a harmful component, such as carbon monoxide (CO), hydrocarbon (HC), and nitrogen oxide (NOx). Regulations on emission amounts of these harmful components have been tightened year by year. To remove these harmful components, a noble metal, such as platinum (Pt), palladium (Pd), and rhodium (Rh), has been used as a catalyst.

Meanwhile, from an aspect of resource risk, reduction in usage of the noble metal has been demanded. As one method for reducing the usage of the noble metal in an exhaust gas purification device, there has been known a method in which a noble metal is supported on a carrier in a form of fine particles. For example, JP 2016-147256 A discloses a method for producing an exhaust gas purification material that includes a step of supporting noble metal particles on an oxide carrier to produce a noble metal supported catalyst and a step of performing a heating process on the noble metal supported catalyst under a reducing atmosphere to control sizes of the noble metal particles within a predetermined range.

Additionally, arrangement of a noble metal in an exhaust gas purification device has also been examined. JP 2021-104474 A discloses a device for exhaust gas purification, which includes a substrate and a catalyst coat layer formed on the substrate. The catalyst coat layer has a two-layer structure. The catalyst coat layer includes an upstream portion on an upstream side and a downstream portion on a downstream side in an exhaust gas flow direction, and a part or all of the upstream portion is formed on a part of the downstream portion. The downstream portion contains Rh fine particles having an average particle size of 1.0 nm or more to 2.0 nm or less measured by a transmission electron microscope observation, and a standard deviation a of the particle size of 0.8 nm or less.

### SUMMARY

In the device for exhaust gas purification described in JP 2021-104474 A, when the upstream portion of the catalyst coat layer contains an Oxygen Storage Capacity (OSC) material that stores oxygen in an atmosphere under an oxygen excess atmosphere and discharges oxygen under an oxygen deficient atmosphere, the longer the length of the upstream portion of the catalyst coat layer is, the longer period of time an exhaust gas contacts with the upstream portion of the catalyst coat layer, thus the better OSC performance the device for exhaust gas purification exhibits. However, the present inventors have found through intensive studies that there is a tendency that the longer the length of the upstream portion of the catalyst coat layer is, the more significantly NOx removal performance deteriorates under a high temperature environment.

The present disclosure provides an exhaust gas purification device and a method for manufacturing the same having high OSC performance and allowing efficient removal of NOx even after exposure to a high temperature environment.

The present disclosure provides the following aspects, for example.

1. An exhaust gas purification device comprising:
a substrate including an upstream end through which an exhaust gas is introduced into the device and a downstream end through which the exhaust gas is discharged from the device, the substrate having a length (Ls) between the upstream end and the downstream end;
a first catalyst layer containing a rhodium-containing catalyst containing a metal oxide carrier and rhodium particles supported on the metal oxide carrier, the first catalyst layer extending across a first region, the first region extending between the downstream end and a first position, the first position being at a first distance (La) from the downstream end toward the upstream end; and
a second catalyst layer containing palladium particles and a material having a basicity higher than a basicity of the metal oxide carrier, the second catalyst layer extending across a second region, the second region extending between the upstream end and a second position, the second position being at a second distance (Lb) from the upstream end toward the downstream end,
wherein the length (Ls), the first distance (La), and the second distance (Lb) meet Ls<La+Lb, and wherein a mean of a particle size distribution of the rhodium particles is from 1.5 nm to 18 nm.
   2. The exhaust gas purification device according to Aspect 1,
wherein a standard deviation of the particle size distribution of the rhodium particles is less than 1.6 nm.
   3. The exhaust gas purification device according to Aspect 1 or 2,
wherein the mean of the particle size distribution of the rhodium particles is more than 4 nm and equal to or less than 14 nm.
   4. The exhaust gas purification device according to any one of Aspects 1 to 3,
wherein the rhodium-containing catalyst contains the rhodium particles in an amount of 0.01 wt % to 3.0 wt % based on a total weight of the metal oxide carrier and the rhodium particles.
   5. The exhaust gas purification device according to any one of Aspects 1 to 4,
wherein the material having the basicity higher than the basicity of the metal oxide carrier is a barium compound.
   6. The exhaust gas purification device according to any one of Aspects 1 to 5,
wherein the length (Ls), the first distance (La), and the second distance (Lb) meet 1.1 Ls≤La+Lb≤1.8 Ls.
   7. The exhaust gas purification device according to any one of Aspects 1 to 6,
wherein the length (Ls), the first distance (La), and the second distance (Lb) meet 1.3 Ls≤La+Lb≤1.8 Ls.
   8. The exhaust gas purification device according to any one of Aspects 1 to 7,
wherein the metal oxide carrier is a composite oxide containing alumina and zirconia as main components.
   9. A method for manufacturing the exhaust gas purification device according to any one of Aspects 1 to 8, the method comprising:
preparing the rhodium-containing catalyst containing the metal oxide carrier and the rhodium particles supported on the metal oxide carrier, wherein the mean of the particle size distribution of the rhodium particles is from 1.5 nm to 18 nm;
forming the first catalyst layer containing the rhodium-containing catalyst in the first region extending between the downstream end of the substrate and the first position, the first position being at the first distance (La) from the downstream end toward the upstream end; and
forming the second catalyst layer containing the palladium particles and the material having the basicity higher than the basicity of the metal oxide carrier in the second region extending between the upstream end of the substrate and the second position, the second position being at the second distance (Lb) from the upstream end toward the downstream end.
   10. The method according to Aspect 9,
wherein the preparing the rhodium-containing catalyst includes the steps, in this order, of:
   impregnating the metal oxide carrier with a rhodium compound solution;
   drying the metal oxide carrier impregnated with the rhodium compound solution; and
   heating the dried metal oxide carrier to a temperature within a range from 700° C. to 900° C. under an inert atmosphere to obtain the rhodium-containing catalyst.
      11. The method according to Aspect 10,
wherein the inert atmosphere is a nitrogen atmosphere.

The exhaust gas purification device of the present disclosure has high OSC performance and allows efficient removal of a harmful component even after exposure to a high temperature environment.

### BRIEF DESCRIPTION OF THE DRAWINGS

FIG. 1 is an enlarged end view of a main part of an exhaust gas purification device according to an embodiment taken along a surface parallel to a flow direction of an exhaust gas and schematically illustrating a configuration at a proximity of a partition wall of a substrate;

FIG. 2 is a perspective view schematically illustrating an example of the substrate;

FIG. 3 is a graph showing OSC performances (Cmax) of exhaust gas purification devices of Examples and Comparative Examples after aging at a high temperature; and

FIG. 4 is a graph showing NOx removal performances (NOx-T50) of exhaust gas purification devices of Examples and Comparative Examples after aging at a high temperature.

### DETAILED DESCRIPTION

The following will describe embodiments with reference to the drawings as appropriate. The present disclosure is not limited to the following embodiments, and can be subjected to various kinds of changes in design without departing from the spirit of the present disclosure described in the claims. In the drawings referred in the following description, the same reference numerals may be used for the same members or the members having similar functions, and their repeated explanations may be omitted in some cases. There may be a case where a dimensional ratio in a drawing differs from the actual ratio for convenience of explanation, or a part of the member is omitted in a drawing. A numerical range expressed herein using the term “to” includes respective values described before and after the term “to” as a lower limit value and an upper limit value. Upper limit values and lower limit values in numerical ranges disclosed herein can be arbitrarily combined.

I. Exhaust Gas Purification Device

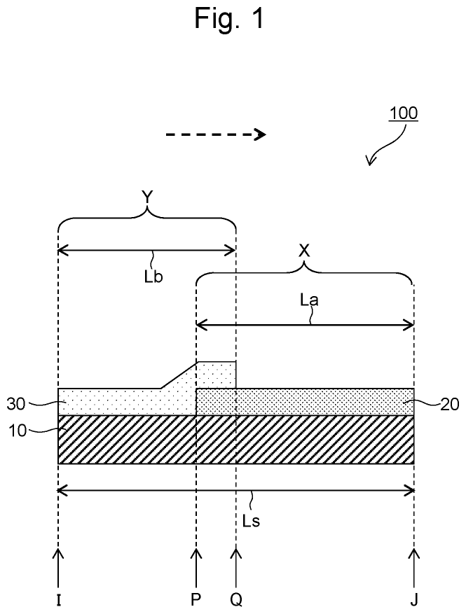

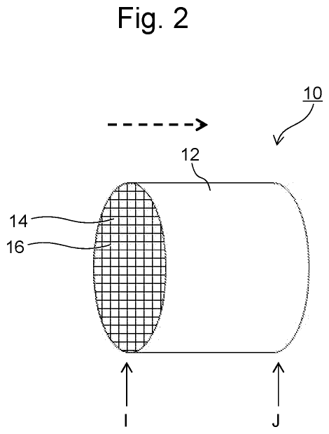

An exhaust gas purification device 100 according to an embodiment will be described with reference to FIGS. 1 and 2. The exhaust gas purification device 100 according to the embodiment includes a substrate 10, a first catalyst layer 20, and a second catalyst layer 30.

(1) Substrate 10

The substrate 10 is not specifically limited, and any substrate that can be used as the substrate for the exhaust gas purification device can be used. For example, as illustrated in FIG. 2, the substrate 10 may include a frame portion 12 and partition walls 16 that partition a space inside the frame portion 12 to define a plurality of cells 14. The frame portion 12 and the partition walls 16 may be integrally formed. The frame portion 12 may have any shape, such as a cylindrical shape, an elliptical cylindrical shape, or a polygonal cylindrical shape. The partition walls 16 are disposed to extend between a first end (first end surface) I and a second end (second end surface) J of the substrate 10 to define the plurality of cells 14 extending between the first end I and the second end J. Each cell 14 may have any cross-sectional shape, such as a quadrilateral shape (e.g. a square, a parallelogram, a rectangular, or a trapezoid), a triangular shape, any other polygonal shape (e.g., a hexagon or an octagon), or a circular shape. Each of the plurality of cells 14 may be closed at either of the first end I or the second end J, or may be opened at both of the first end I and the second end J.

Examples of the material of the substrate 10 include ceramic, such as cordierite (2MgO·2Al₂O₃·5SiO₂), aluminum titanate, silicon carbide, silica, alumina, and mullite, and a metal, such as stainless steel containing chrome and aluminum. These materials allow the exhaust gas purification device 100 to exhibit high exhaust gas purification performance even under a high temperature condition. From the aspect of cost reduction, the substrate 10 may be made from cordierite.

In FIGS. 1 and 2, the dashed arrows indicate a flow direction of an exhaust gas in the exhaust gas purification device 100 and the substrate 10. The exhaust gas is introduced into the exhaust gas purification device 100 through the first end I, and discharged from the exhaust gas purification device 100 through the second end J. Therefore, hereinafter, the first end I will also be referred to as an upstream end I and the second end J will also be referred to as a downstream end J as appropriate. A length between the upstream end I and the downstream end J, that is, the total length of the substrate 10 is herein denoted as Ls.

(2) First Catalyst Layer 20

The first catalyst layer 20 is disposed on the substrate 10 and extends across a first region X extending between the downstream end J and a first position P, which is at a first distance La from the downstream end J toward the upstream end I (that is, in a direction opposite to the flow direction of the exhaust gas). The first distance La may be from 80% to 100% of the total length Ls of the substrate 10.

The first catalyst layer 20 contains a rhodium-containing catalyst. The rhodium-containing catalyst contains a metal oxide carrier and rhodium (Rh) particles supported on the metal oxide carrier.

Examples of the metal oxide carrier include an oxide of at least one metal selected from the group consisting of metals of the group 3, the group 4, and the group 13 in the periodic table of elements and lanthanoid-based metals. When the metal oxide carrier contains two or more metal elements, the metal oxide carrier may be a mixture of oxides of the two or more metal elements, may be a composite oxide containing the two or more metal elements, or may be a mixture of an oxide of at least one metal element and at least one composite oxide.

For example, the metal oxide carrier may be an oxide of at least one metal selected from the group consisting of scandium (Sc), yttrium (Y), lanthanum (La), cerium (Ce), neodymium (Nd), samarium (Sm), europium (Eu), lutetium (Lu), titanium (Ti), zirconium (Zr), and aluminum (Al), an oxide of at least one metal selected from the group consisting of Y, La, Ce, Ti, Zr and Al in some embodiments, or an oxide of at least one metal selected from the group consisting of Al, Ce, and Zr in some embodiments. The metal oxide carrier may be an oxide containing zirconia (ZrO₂) as the main component, may be an Al—Zr-based composite oxide, which is a composite oxide containing zirconia and alumina (Al₂O₃) as the main components, or may be an Al—Ce—Zr-based composite oxide, which is a composite oxide containing zirconia, alumina, and ceria (CeO₂) as the main components. The zirconia may serve to maintain catalytic activity of the Rh particles. The ceria may serve as an Oxygen Storage Capacity (OSC) material which stores oxygen in an atmosphere under an oxygen excess atmosphere and discharges oxygen under an oxygen deficient atmosphere. However, the metal oxide carrier need not contain a Ce element because the particle sizes of the Rh particles on the ceria (CeO₂) are likely to increase under a high temperature environment. The alumina may serve to control diffusion of the Rh particles. The metal oxide carrier may be a composite oxide containing at least one of alumina, ceria, or zirconia as the main component(s), and further containing at least one of yttria (Y₂O₃), lanthana (La₂O₃), neodymia (Nd₂O₃), or praseodymia (Pr₆O₁₁). Yttria, lanthana, neodymia, and praseodymia improve heat resistance of the composite oxide.

Note that, the phrase “contain as the main component(s)” herein means that the content of the referred component is 50 wt % or more, 70 wt % or more, 80 wt % or more, or 90 wt % or more of the total weight. When a plurality of main components are present, the phrase means that the sum of the contents of the components is 50 wt % or more, 70 wt % or more, 80 wt % or more, or 90 wt % or more.

The metal oxide carrier may be particulate, and may have any appropriate particle size.

The Rh particles supported on the metal oxide carrier function as a catalyst to remove harmful components contained in an exhaust gas and mainly function as a catalyst to reduce NOx. A mean of a particle size distribution of the Rh particles may be within the range from 1.5 nm to 18 nm. Generally, the smaller the sizes of the Rh particles are, the larger specific surface area the Rh particles have, and therefore the higher catalyst performance the Rh particles exhibit. However, the Rh particle having an excessively small particle size (for example, a particle size less than about 1 nm) tends to easily coarsen due to Ostwald ripening and aggregation etc. under a high temperature environment, leading to deterioration of catalyst performance. When the mean of the particle size distribution of the Rh particles is 1.5 nm or more, a small number of the Rh particles that easily coarsen is present, and therefore the deterioration of the catalyst performance under a high temperature environment is reduced or prevented. When the mean of the particle size distribution of the Rh particles is 18 nm or less, the Rh particles have sufficiently large specific surface areas, and therefore the Rh particles can provide high catalyst performance. The mean of the particle size distribution of the Rh particles may be from 3 nm to 17 nm, more than 4 nm and equal to or less than 14 nm, or more than 4 nm and equal to or less than 8 nm.

Additionally, a standard deviation of the particle size distribution of the Rh particles may be less than 1.6 nm. When the standard deviation of the particle size distribution of the Rh particles is less than 1.6 nm, a small number of coarse Rh particles and a small number of fine Rh particles likely to coarsen under a high temperature environment are present. Therefore, even after the exhaust gas purification device is exposed to a high temperature environment, the Rh particles can have the sufficiently large specific surface area, and as a result, the high catalyst performance can be provided. The standard deviation of the particle size distribution of the Rh particles may be 1 nm or less.

The particle size distribution of the Rh particles herein is a particle size distribution on the number basis (i.e., a number-weighted particle size distribution) determined by measuring a projected area equivalent circle diameter of 50 or more of the Rh particles using an image obtained with a transmission electron microscope (TEM).

The amount of the supported Rh particles, that is, the proportion of the Rh particles based on the total weight of the metal oxide carrier and the Rh particles, may be within the range from 0.01 wt % to 3.0 wt %. The proportion of the Rh particles of 0.01 wt % or more allows satisfactory removal of the harmful components from the exhaust gas by virtue of the sufficient amount of the Rh particles present. The proportion of the Rh particles of 3.0 wt % or less allows reducing the amount of Rh used, and additionally allows exhibiting sufficient durability against a high temperature because coarsening of the Rh particles under a high temperature environment is avoided or controlled owing to sparseness of the Rh particles supported on the metal oxide carrier. The proportion of the Rh particles based on the total weight of the metal oxide carrier and the Rh particles may be within the range from 0.2 wt % to 3.0 wt %.

The content of the Rh particles in the first catalyst layer 20 may be, for example, from 0.05 g/L to 5 g/L, from 0.1 g/L to 3 g/L, or more than 0.7 g/L and equal to or less than 2 g/L, based on the volume capacity of the substrate in the first region X. This allows the exhaust gas purification device 100 to have a sufficiently high exhaust gas purification performance.

The first catalyst layer 20 may further contain any other component. Examples of the any other component include an OSC material, a binder, and an additive.

Examples of the OSC material includes ceria and a composite oxide containing ceria (for example, a composite oxide containing ceria as the main component, a Ce—Zr-based composite oxide, which is a composite oxide containing ceria and zirconia as the main components, and an Al—Ce—Zr-based composite oxide, which is a composite oxide containing alumina, ceria, and zirconia as the main components). Especially, the Ce—Zr-based composite oxide may be used in some embodiments because the Ce—Zr-based composite oxide has high oxygen storage capacity and are relatively inexpensive. The Ce—Zr-based composite oxide may have a pyrochlore crystalline structure. In addition to the main component(s), the composite oxide containing ceria may further contain at least one of lanthana, yttria, neodymia, or praseodymia as an additive, and the additives may form a composite oxide together with the main component(s). The OSC material may be particulate, and may have any appropriate particle size.

The content of the Ce element in the first catalyst layer 20 may be, for example, from 5 g/L to 50 g/L based on the volume capacity of the substrate in the first region X.

(3) Second Catalyst Layer 30

The second catalyst layer 30 is disposed on the substrate 10 and extends across a second region Y extending between the upstream end I and a second position Q, which is at a second distance Lb from the upstream end I toward the downstream end J (that is, in the flow direction of the exhaust gas). The second distance Lb may be from 30% to 80% of the total length Ls of the substrate 10. The length Ls of the substrate, the first distance La, and the second distance Lb meet Ls<La+Lb. That is, there is a region where the first catalyst layer 20 overlaps with the second catalyst layer 30. This allows the exhaust gas purification device 100 to have high OSC performance. In the region where the first catalyst layer 20 overlaps with the second catalyst layer 30, the second catalyst layer 30 may be formed on the first catalyst layer 20 as shown in FIG. 1, or the first catalyst layer 20 may be formed on the second catalyst layer 30. The length Ls of the substrate, the first distance La, and the second distance Lb may meet 1.1 Ls≤La+Lb 1.8 Ls, especially, 1.3 Ls≤La+Lb≤1.8 Ls. That is, the length of the region where the first catalyst layer 20 overlaps with the second catalyst layer 30 may be from 10% to 80% or from 30% to 80% of the total length Ls of the substrate 10. This allows the exhaust gas purification device 100 to have further high OSC performance.

The second catalyst layer 30 contains palladium (Pd) particles. The Pd particles function as a catalyst to remove a harmful component contained in an exhaust gas, and mainly function as a catalyst to oxidize HC. Similarly to the Rh particles, the smaller the sizes of the Pd particles are, the higher catalyst performance the Pd particles exhibit, but the more likely the Pd particles coarsen under a high temperature environment. However, even when a mean of a particle size distribution of the Pd particles is within the range from 1.5 nm to 18 nm similarly to the Rh particles, coarsening of the Pd particles cannot be avoided or controlled. Therefore, the mean of the particle size distribution of the Pd particles is not specifically limited. From a perspective of ease of production, the mean of the particle size distribution of the Pd particles may be within the range, for example, from 0.5 nm to 10 nm, and a standard deviation of the particle size distribution of the Pd particles may be within the range from 0.1 nm to 3.0 nm.

The particle size distribution of the Pd particles herein is a particle size distribution on the number basis (i.e., a number-weighted particle size distribution) determined by measuring a projected area equivalent circle diameter of 50 or more of the Pd particles using an image obtained with a transmission electron microscope (TEM) or a scanning electron microscope (SEM).

The content of the Pd particles in the second catalyst layer 30 may be, for example, from 0.1 g/L to 20 g/L, based on the volume capacity of the substrate in the second region Y, from 1 g/L to 15 g/L, based on the volume capacity of the substrate in the second region Y, in some embodiments, or from 3 g/L to 9 g/L, based on the volume capacity of the substrate in the second region Y, in some embodiments. This allows the exhaust gas purification device 100 to have a sufficiently high exhaust gas purification performance.

In addition to the Pd particles, the second catalyst layer 30 contains a high basicity material, which is a material having a basicity higher than that of the above-described metal oxide carrier contained in the rhodium-containing catalyst. The second catalyst layer 30 may contain at least one of a carrier on which the Pd particles are supported, an OSC material, or a barium compound, and this may be the high basicity material. Specifically, the high basicity material may be a barium compound.

As the carrier of the Pd particles, for example, the metal oxide carrier can be used, but the carrier is not limited to the metal oxide. The Pd particles can be supported on a carrier by any method, such as an impregnation supporting method, an adsorption supporting method, and a water-absorption supporting method.

Examples of the metal oxide carrier include an oxide of at least one metal selected from the group consisting of metals of the group 3, the group 4, and the group 13 in the periodic table of elements and lanthanoid-based metals. When the metal oxide carrier contains two or more metal elements, the metal oxide carrier may be a mixture of oxides of the two or more metal elements, may be a composite oxide containing the two or more metal elements, or may be a mixture of an oxide of at least one metal element and at least one composite oxide.

For example, the metal oxide carrier may be an oxide of at least one metal selected from the group consisting of scandium (Sc), yttrium (Y), lanthanum (La), cerium (Ce), neodymium (Nd), samarium (Sm), europium (Eu), lutetium (Lu), titanium (Ti), zirconium (Zr), and aluminum (Al), an oxide of at least one metal selected from the group consisting of Y, La, Ce, Ti, Zr and Al in some embodiments, and an oxide of at least one metal selected from the group consisting of Al, Ce, and Zr in some embodiments. The metal oxide carrier may be a composite oxide containing at least one of zirconia, alumina, or ceria as the main component. The ceria can also function as an OSC material. The metal oxide carrier may be a composite oxide containing at least one of alumina, ceria, or zirconia as the main component(s), and further containing at least one of yttria, lanthana, neodymia, or praseodymia. Yttria, lanthana, neodymia, and praseodymia improve heat resistance of the composite oxide.

The metal oxide carrier may be particulate, and may have any appropriate particle size.

Examples of the OSC material includes ceria and a composite oxide containing ceria (for example, a composite oxide containing ceria as the main component, a Ce—Zr-based composite oxide, which is a composite oxide containing ceria and zirconia as the main components, and an Al—Ce—Zr-based composite oxide, which is a composite oxide containing alumina, ceria, and zirconia as the main components). Especially, the Ce—Zr-based composite oxide may be used in some embodiments because the Ce—Zr-based composite oxide has high oxygen storage capacity and are relatively inexpensive. The Ce—Zr-based composite oxide may have a pyrochlore crystalline structure. In addition to the main component(s), the composite oxide containing ceria may further contain at least one of lanthana, yttria, neodymia, or praseodymia as an additive, and the additives may form a composite oxide together with the main component. The OSC material may be particulate, and may have any appropriate particle size.

The content of the Ce element in the second catalyst layer 30 may be, for example, from 5 g/L to 30 g/L based on the volume capacity of the substrate in the second region Y.

The barium compound can prevent or control poisoning of the Pd particles. Examples of the barium compound include barium sulfate, barium carbonate, barium oxide, and barium nitrate. The barium compound may be particulate, and may have any appropriate particle size. The content of the Ba element in the second catalyst layer 30 may be, for example, from 3 g/L to 15 g/L based on the volume capacity of the substrate in the second region Y.

“A material having a basicity higher than that of the metal oxide carrier” is herein defined as a material having average electronegativity smaller than average electronegativity of the metal oxide carrier. The “average electronegativity” is an average of Pauling electronegativities (hereinafter simply referred to as “electronegativity”) of constituent elements weighted by the numbers of the respective elements per unit weight.

For example, the average electronegativity of AZ particles which are composite oxide particles containing Al₂O₃, ZrO₂, La₂O₃, Y₂O₃, and Nd₂O₃ by the following weight fractions, Al₂O₃: 30 wt %, ZrO₂: 60 wt %, La₂O₃: 4 wt %, Y₂O₃: 4 wt %, and Nd₂O₃: 2 wt %, is calculated as follows.

Average Electronegativity of AZ Particles
=electronegativity of Al×weight fraction of Al₂O₃/formula weight of Al₂O₃×2
+electronegativity of Zr×weight fraction of ZrO₂/formula weight of ZrO₂
+electronegativity of La×weight fraction of La₂O₃/formula weight of La₂O₃×2
+electronegativity of Y×weight fraction of Y₂O₃/formula weight of Y₂O₃×2
+electronegativity of Nd×weight fraction of Nd₂O₃/formula weight of Nd₂O₃×2
+electronegativity of O×(weight fraction of Al₂O₃/formula weight of Al₂O₃×3+weight fraction of ZrO₂/formula weight of ZrO₂×2+weight fraction of La₂O₃/formula weight of La₂O₃×3+weight fraction of Y₂O₃/formula weight of Y₂O₃×3+weight fraction of Nd₂O₃/formula weight of Nd₂O₃×3)
=1.61×0.3/101.9×2
+1.33×0.6/123.2
+1.10×0.04/325.8×2
+1.22×0.04/225.8×2
+1.14×0.02/336.4×2
+3.44×(0.3/101.9×3+0.6/123.2×2+0.04/325.8×3+0.04/225.8×3+0.02/336.4×3)
=0.084

The average electronegativity of Al₂O₃ particles which are composite oxide particles containing Al₂O₃ and La₂O₃ by the following weight fractions, Al₂O₃: 96 wt % and La₂O₃: 4 wt %, is calculated as follows.

Average Electronegativity of Al₂O₃ Particles
=electronegativity of Al×weight fraction of Al₂O₃/formula weight of Al₂O₃×2
+electronegativity of La×weight fraction of La₂O₃/formula weight of La₂O₃×2
+electronegativity of O×(weight fraction of Al₂O₃/formula weight of Al₂O₃×3+weight fraction of La₂O₃/formula weight of La₂O₃×3)
=1.61×0.96/101.9×2
+1.10×0.04/325.8×2
+3.44×(0.96/101.9×3+0.04/325.8×3)
=0.129

The average electronegativity of ACZ particles which are composite oxide particles containing Al₂O₃, CeO₂, ZrO₂, La₂O₃, Y₂O₃, and Nd₂O₃ by the following weight fractions, Al₂O₃: 30 wt %, CeO₂: 20 wt %, ZrO₂: 44 wt %, La₂O₃: 2 wt %, Y₂O₃: 2 wt %, and Nd₂O₃: 2 wt %, is calculated as follows.

Average Electronegativity of ACZ Particles
=electronegativity of Al×weight fraction of Al₂O₃/formula weight of Al₂O₃×2
+electronegativity of Ce×weight fraction of CeO₂/formula weight of CeO₂
+electronegativity of Zr×weight fraction of ZrO₂/formula weight of ZrO₂
+electronegativity of La×weight fraction of La₂O₃/formula weight of La₂O₃×2
+electronegativity of Y×weight fraction of Y₂O₃/formula weight of Y₂O₃×2
+electronegativity of Nd×weight fraction of Nd₂O₃/formula weight of Nd₂O₃×2
+electronegativity of O×(weight fraction of Al₂O₃/formula weight of Al₂O₃×3+weight fraction of CeO₂/formula weight of CeO₂×2+weight fraction of ZrO₂/formula weight of ZrO₂×2+weight fraction of La₂O₃/formula weight of La₂O₃×3+weight fraction of Y₂O₃/formula weight of Y₂O₃×3+weight fraction of Nd₂O₃/formula weight of Nd₂O₃×3)
=1.61×0.3/101.9×2
+1.12×0.2/172.1
+1.33×0.44/123.2
+1.10×0.02/325.8×2
+1.22×0.02/225.8×2
+1.14×0.02/336.4×2
+3.44× (0.3/101.9×3+0.2/172.1×2+0.44/123.2×2+0.02/325.8×3+0.02/225.8×3+0.02/336.4×3)
=0.081

The average electronegativity of CZ particles which are composite oxide particles containing CeO₂, ZrO₂, and Pr₆O₁₁ by the following weight fractions, CeO₂: 51.4 wt %, ZrO₂: 45.6 wt %, and Pr₆O₁₁: 3.0 wt %, is calculated as follows.

Average Electronegativity of CZ Particles
=electronegativity of Ce×weight fraction of CeO₂/formula weight of CeO₂
+electronegativity of Zr×weight fraction of ZrO₂/formula weight of ZrO₂
+electronegativity of Pr×weight fraction of Pr₆O₁/formula weight of Pr₆O₁₁×6
+electronegativity of O×(weight fraction of CeO₂/formula weight of CeO₂×2+weight fraction of ZrO₂/formula weight of ZrO₂×2+weight fraction of Pr₆O₁/formula weight of Pr₆O₁₁×11)
=1.12×0.514/172.1
+1.33×0.456/123.2
+1.13×0.03/1021.4×6
+3.44×(0.514/172.1×2+0.456/123.2×2+0.03/1021.4×11)
=0.056

The average electronegativity of barium sulfate particles which are particles made of barium sulfate (BaSO₄) is calculated as follows.

Average Electronegativity of Barium Sulfate Particles
=(electronegativity of Ba+electronegativity of S+electronegativity of O×4)/formula weight of BaSO₄
=(0.89+2.58+3.44×4)/233.4
=0.074

From the above-described calculation, the above-described ACZ particles, CZ particles, and barium sulfate particles have the average electronegativity smaller than that of the AZ particles, and thus, have the basicity higher than that of the AZ particles. The Al₂O₃ particles have the average electronegativities larger than that of the AZ particles, and thus, have the basicity lower than that of the AZ particles.

The present inventors have found that the basic material has high surface energy through first-principles calculation. Since the Rh particles supported on the surface of the basic material is unstable, Rh atoms contained in the Rh particles on the basic material are likely to move. Therefore, the Rh particles on the high basicity material are more likely to coarsen compared with the Rh particles on the metal oxide carrier. In a case where the most Rh particles in the first catalyst layer 20 have excessively small particle sizes (for example, particle sizes less than about 1 nm) and the first catalyst layer 20 overlaps with the second catalyst layer 30 containing the high basicity material, the Rh atoms in the excessively small Rh particles move onto the high basicity material under a high temperature environment due to Ostwald ripening, coarse Rh particles are formed on the high basicity material, and as a result, exhaust gas purification performance is likely to decrease. However, in the exhaust gas purification device 100 according to the embodiment, the particle size distribution of the Rh particles on the metal oxide carrier is controlled to reduce the number of the Rh particles that are likely to coarsen. Thus, Ostwald ripening under a high temperature environment is prevented or controlled, and formation of coarse Rh particles on the high basicity material is prevented or controlled. Therefore, in the exhaust gas purification device 100 according to the embodiment, the decrease in exhaust gas purification performance under a high temperature environment caused by having the region where the first catalyst layer 20 overlaps with the second catalyst layer 30 is prevented or controlled.

The second catalyst layer 30 may further contain any other component. Examples of the any other component include a binder and an additive.

II. Method for Manufacturing Exhaust Gas Purification Device

An example of the method for manufacturing the exhaust gas purification device 100 according to the embodiment will be described. The method for manufacturing the exhaust gas purification device 100 includes preparing a rhodium-containing catalyst, forming the first catalyst layer 20 in the first region X of the substrate 10, and forming the second catalyst layer 30 in the second region Y of the substrate 10. Either of the first catalyst layer 20 or the second catalyst layer 30 may be formed first.

An example of the procedure for preparing the rhodium-containing catalyst will be described. The rhodium-containing catalyst can be prepared by impregnating a metal oxide carrier with a rhodium compound solution, drying the metal oxide carrier impregnated with the rhodium compound solution, and heating the dried metal oxide carrier to a temperature within the range from 700° C. to 900° C. under an inert atmosphere.

Examples of the rhodium compound solution include an aqueous solution of rhodium hydroxide and an aqueous solution of rhodium nitrate. The impregnation method is not specifically limited. For example, while distilled water is stirred, the metal oxide carrier and the rhodium compound solution are added to the distilled water to allow the metal oxide carrier to be impregnated with the rhodium compound solution.

Next, the metal oxide carrier impregnated with the rhodium compound solution is dried. Baking may be performed after drying as appropriate. Afterwards, the metal oxide carrier is heated to the temperature within the range from 700° C. to 900° C. under an inert atmosphere. Thus, the rhodium-containing catalyst containing the metal oxide carrier and the Rh particles supported on the metal oxide carrier is obtained. Examples of the inert atmosphere include a nitrogen atmosphere and an argon atmosphere. The heating period may be any appropriate length of time, and, for example, may be from one to five hours. Heating under the inert atmosphere allows appropriately controlling the particle size distribution of the Rh particles in the rhodium-containing catalyst. Specifically, the mean of the particle size distribution of the Rh particles can be within the range from 1.5 nm to 18 nm, within the range from 3 nm to 17 nm, more than 4 nm and equal to or less than 14 nm, or more than 4 nm and equal to or less than 8 nm, and the standard deviation of the particle size distribution of the Rh particles can be less than 1.6 nm or equal to or less than 1 nm.

Note that it may be difficult to obtain the particle size distribution as described above through baking under a reducing atmosphere such as a hydrogen atmosphere because the Rh particles cannot be sufficiently enlarged under the reducing atmosphere. It should also be noted that heating under an oxidation atmosphere, such as an air atmosphere, causes dissolution of the Rh particles into the metal oxide carrier to form a solid solution, and the Rh particles on the surface of the metal oxide carrier possibly decrease.

The first catalyst layer 20 containing the Rh-containing catalyst prepared as described above is formed in the first region X of the substrate 10. For example, the first catalyst layer 20 can be formed as follows. First, a first slurry containing the Rh-containing catalyst is prepared. The first slurry may further contain any component, such as an OSC material, a binder, or an additive, in addition to the Rh-containing catalyst. Properties of the first slurry, such as viscosity and a particle diameter of a solid component, may be adjusted as appropriate. The prepared first slurry is applied over the first region X of the substrate 10. For example, the first region X of the substrate 10 is immersed in the first slurry, and after a predetermined period has passed, the substrate 10 is taken out of the first slurry, thus allowing the first slurry to be applied over the first region X of the substrate 10. Alternatively, the first slurry may be poured from the downstream end J into the substrate 10, and blown with a blower from the downstream end J to be spread toward the upstream end I, thereby allowing the first region X of the substrate 10 to be coated with the first slurry. Next, the first slurry is dried and baked at a predetermined temperature for a predetermined period. Thus, the first catalyst layer 20 is formed in the first region X of the substrate 10.

The second catalyst layer 30 containing palladium particles and a high basicity material is formed in the second region Y of the substrate 10. The second catalyst layer 30 can be formed as follows, for example. First, a second slurry containing a Pd particle precursor and a high basicity material is prepared. As the Pd particle precursor, for example, an appropriate Pd salt of inorganic acid such as hydrochloride, nitrate, phosphate, sulfate, borate, and hydrofluoride can be used. Alternatively, the second slurry may contain carrier powder on which the Pd particles are supported in advance. The second slurry may further contain any component, such as an OSC material, a binder, or an additive. Properties of the second slurry, such as viscosity and a particle diameter of a solid component, may be adjusted as appropriate. The prepared second slurry is applied over the second region Y of the substrate 10. For example, the second region Y of the substrate 10 is immersed in the second slurry, and after a predetermined period has passed, the substrate 10 is taken out of the second slurry, thus allowing the second slurry to be applied over the second region Y of the substrate 10. Alternatively, the second slurry may be poured from the upstream end I into the substrate 10, and blown with a blower from the upstream end I to be spread toward the downstream end J, thereby allowing the second region Y of the substrate 10 to be coated with the second slurry. Next, the second slurry is dried and baked at a predetermined temperature for a predetermined period. Thus, the second catalyst layer 30 is formed in the second region Y of the substrate 10.

The exhaust gas purification device according to the embodiment is applicable to various kinds of vehicles including internal combustion engines.

### EXAMPLES

The following will specifically describe the present disclosure with the examples, but the present disclosure is not limited to the examples.

(1) Materials Used in Examples and Comparative Examples
a) Substrate (honeycomb substrate)
Material: cordierite
Volume capacity: 875 cc
Length: 10.5 cm
Thickness of partition wall: 2 mil (50.8 m)
Cell density: 600 pieces per square inch
Cross-sectional shape of cell: hexagonal shape

b) AZ Particles

The AZ particles are composite oxide particles containing Al₂O₃ and ZrO₂ as main components and further containing La₂O₃, Y₂O₃, and Nd₂O₃. Weight fractions of the respective components in the AZ particles were Al₂O₃: 30 wt %, ZrO₂: 60 wt %, La₂O₃: 4 wt %, Y₂O₃: 4 wt %, and Nd₂O₃: 2 wt %.

c) Al₂O₃ Particles

The Al₂O₃ particles are composite oxide particles containing Al₂O₃ as the main component and further containing La₂O₃. Weight fractions of the respective components in the Al₂O₃ particles were Al₂O₃: 96 wt % and La₂O₃: 4 wt %.

d) ACZ Particles

The ACZ particles are composite oxide particles containing Al₂O₃, CeO₂, and ZrO₂ as main components and further containing La₂O₃, Y₂O₃, and Nd₂O₃. Weight fractions of the respective components in the ACZ particles were Al₂O₃: 30 wt %, CeO₂: 20 wt %, ZrO₂: 44 wt %, La₂O₃: 2 wt %, Y₂O₃: 2 wt %, and Nd₂O₃: 2 wt %.

e) CZ Particles

The CZ particles are composite oxide particles containing CeO₂ and ZrO₂ as main components and further containing Pr₆O₁₁. Weight fractions of the respective component in the CZ particles were CeO₂: 51.4 wt %, ZrO₂: 45.6 wt %, and Pr₆O₁₁: 3 wt %. In the CZ particles, cerium ions and zirconium ions were arranged on a pyrochlore-type ordered lattice, and parts of the cerium ions and the zirconium ions were replaced by praseodymium. The CZ particles were prepared according to the following procedure.

129.7 g of cerium nitrate hexahydrate, 99.1 g of zirconium oxynitrate dihydrate, 5.4 g of praseodymium nitrate hexahydrate, and 36.8 g of 18% hydrogen peroxide solution were dissolved into 500 g of ion exchanged water, and 340 g of 25% ammonia water was used to obtain a hydroxide precipitate by reverse coprecipitation method. The precipitate was separated with a filter paper, and the obtained precipitate was dried in a drying furnace at 150° C. for seven hours to remove water content, baked in an electric furnace at 500° C. for four hours, and then pulverized.

The obtained powder was molded by applying a pressure of 2000 kgf/cm² using a pressure molding machine (Wet-CIP).

The obtained molded body was reduced under an Ar atmosphere at 1700° C. in a graphite crucible in which activated carbons were placed for five hours, and after that was baked in an electric furnace at 500° C. for five hours.

The resulting product was pulverized using a vibration mill. Thus, the CZ particles were obtained.
f) Aqueous solution of rhodium nitrate (concentration 2.8 wt %)
g) Aqueous solution of palladium nitrate (concentration 8.0 wt %)
h) Barium sulfate particles

(2) Manufacturing Exhaust Gas Purification Device

### Examples 1 to 3

a) Preparation of Rhodium-Containing Catalyst

While distilled water was stirred, the AZ particles and the aqueous solution of rhodium nitrate were added to the distilled water in order of mention. The obtained mixture was dried, and then baked by heating it in an electric furnace under an air atmosphere at 500° C. for two hours. The obtained particles were heated under a nitrogen atmosphere at 850° C. for five hours. Thus, an Rh-containing catalyst containing the AZ particles and rhodium (Rh) particles supported on the AZ particles was obtained. The Rh-containing catalyst contained the Rh particles in an amount of 2.6 wt % based on the total weight of the AZ particles and the Rh particles.

The Rh-containing catalyst was observed with a transmission electron microscope (TEM) to determine the particle size distribution of the Rh particles (initial Rh particles) supported on the ACZ particles. Table 1 shows the mean and the standard deviation of the particle size distribution of the initial Rh particles.

b) Manufacturing Exhaust Gas Purification Device

While distilled water was stirred, the Rh-containing catalyst, the Al₂O₃ particles, the ACZ particles, the CZ particles, and an Al₂O₃-based binder were added to the distilled water to prepare a suspended first slurry. Next, the first slurry was poured from one end (downstream end) of a substrate, and an excess amount of the first slurry was blown off by a blower. Thus, the layer of the first slurry was formed on the substrate in a first region between the downstream end of the substrate and a first position which was distant from the downstream end toward the upstream end of the substrate by 80% of the total length of the substrate. Next, the substrate was placed on a dryer inside of which was held at 120° C. for two hours to vaporize the water in the first slurry layer. Next, the substrate was heated in an electric furnace at 500° C. for two hours under an air atmosphere to bake the first slurry layer. Thus, the first catalyst layer was formed.

The contents of the Rh-containing catalyst, the Al₂O₃ particles, the ACZ particles, and the CZ particles in the first catalyst layer were 30.8 g/L (including 30 g/L of the AZ particles and 0.8 g/L of the Rh particles), 35 g/L, 75 g/L, and 15 g/L, respectively, based on the volume capacity of the substrate in the first region.

While distilled water was stirred, the Al₂O₃ particles, the ACZ particles, the CZ particles, the aqueous solution of palladium nitrate, the barium sulfate particles, and the Al₂O₃-based binder were added to the distilled water to prepare a suspended second slurry. Next, the second slurry was poured from the upstream end of the substrate, and an excess amount of the second slurry was blown off by a blower. Thus, the layer of the second slurry was formed on the substrate or on the first catalyst layer in a second region between the upstream end of the substrate and a second position which was at a predetermined distance from the upstream end toward the downstream end of the substrate. Next, the substrate was placed on a dryer inside of which was held at 120° C. for two hours to vaporize the water in the second slurry layer. Next, the substrate was heated in an electric furnace at 500° C. for two hours under an air atmosphere to bake the second slurry layer. Thus, the second catalyst layer was formed. Note that the distance from the upstream end of the substrate to the second position (that is, the length of the second catalyst layer) based on the total length of the substrate was as described in Table 1.

The contents of the Al₂O₃ particles, the ACZ particles, the CZ particles, the Pd particles derived from the aqueous solution of palladium nitrate, and the barium sulfate particles in the second catalyst layer based on the volume capacity of the substrate in the second region were 50 g/L, 100 g/L, 10 g/L, 7.0 g/L, and 13 g/L, respectively.

Thus, exhaust gas purification devices of Examples 1 to 3 were obtained.

### Comparative Example 1

Except that the length of the second catalyst layer based on the total length of the substrate was described in Table 1, an exhaust gas purification device was manufactured similarly to Example 1.

### Comparative Examples 2 to 5

a) Preparation of Rhodium-Containing Catalyst

Except that the heating under the nitrogen atmosphere was not performed, an Rh-containing catalyst was prepared similarly to Example 1. The Rh-containing catalyst was observed with a TEM to determine the particle size distribution of the Rh particles (initial Rh particle) supported on the AZ particles. Table 1 shows the mean and the standard deviation of the particle size distribution of the initial Rh particles.

b) Manufacturing Exhaust Gas Purification Device

Except that the Rh-containing catalyst prepared without performing the heating under the nitrogen atmosphere was used and the length of the second catalyst layer based on the total length of the substrate was described in Table 1, an exhaust gas purification device was manufactured similarly to Example 1.

### Example 4

Except that a second catalyst layer was formed without using the barium sulfate particles, an exhaust gas purification device was manufactured similarly to Example 2.

(3) Aging Process and Measurement of Average Particle Size of Rh Particles after Aging Process

Each of the exhaust gas purification devices of Examples 1 to 4 and Comparative Examples 1 to 5 was connected to an exhaust system of a V8 engine, a stoichiometric air-fuel mixture (air-fuel ratio A/F=14.6) and a lean air-fuel mixture containing excess oxygen (A/F>14.6) were alternately introduced into the engine with a time ratio of 3:1 at a fixed cycle of time, and a bed temperature of the exhaust gas purification device was maintained at 950° C. for 50 hours. Thus, the exhaust gas purification devices were aged. Afterwards, the average particle sizes of the Rh particles in the first catalyst layers of the exhaust gas purification devices of Example 3 and Comparative Example 4 and the average particle sizes of the Rh particles in the second catalyst layers of the exhaust gas purification devices of Examples 1 to 3 and Comparative Examples 2 to 4 were determined by carbon monoxide pulse method. Table 1 shows the results.

(4) OSC Performance Evaluation

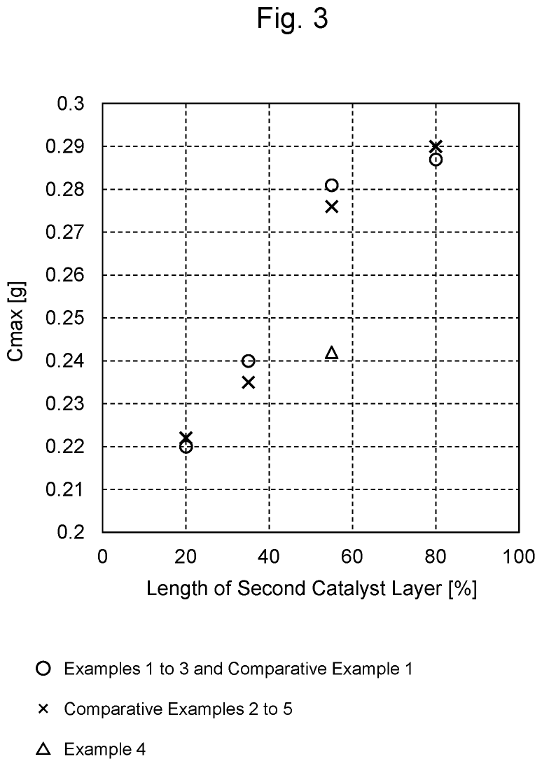

The exhaust gas purification device which had been aged as described above was connected to an exhaust system of an L4 engine, an air-fuel mixture with an air-fuel ratio A/F of 14.1 and an air-fuel mixture with an air-fuel ratio A/F of 15.1 were alternately supplied to the engine, and the maximum oxygen storage amount (Cmax) was calculated by the formula: Cmax (g)=0.23×ΔA/F× fuel injection amount. Note that ΔA/F represents a difference between a stoichiometric point and an A/F sensor output. Table 1 and FIG. 3 show the results.

(5) NOx Removal Performance Evaluation

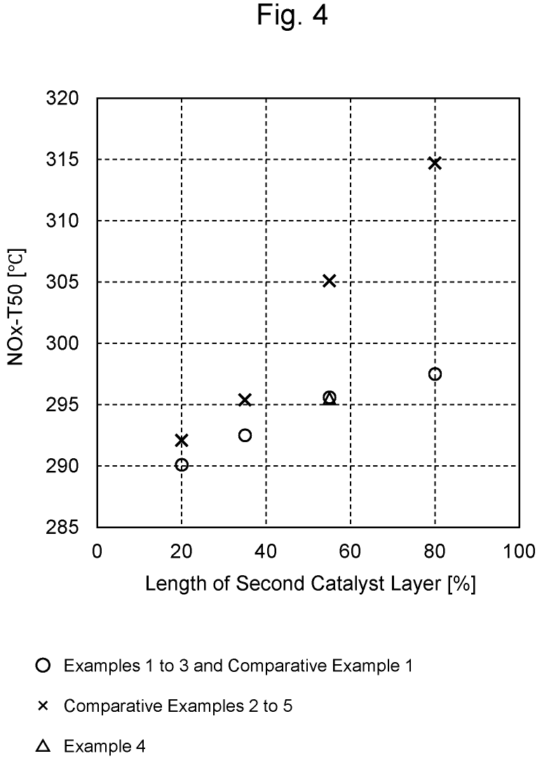

The exhaust gas purification device which had been aged as described above was connected to an exhaust system of an L4 engine, an air-fuel mixture with an air-fuel ratio A/F of 14.4 was supplied to the engine at an air flow rate of 30 g/s, the bed temperature of the exhaust gas purification device was increased from 200° C. to 500° C. at a rate of 20° C./minute, and “NOx-T50”, which was a bed temperature when 50% of NOx in the gas was removed, was measured. Table 1 and FIG. 4 show the results.

As illustrated in FIG. 3, regardless of the particle size distribution of the initial Rh particles, the longer the second catalyst layer, the higher the Cmax (i.e., the better the OSC performance). It is considered that the reason why the longer second catalyst layer brought the higher OSC performance is that the longer second catalyst layer, which contained the ACZ particles and the CZ particles both of which acted as the OSC material, allowed the exhaust gas to contact the OSC material in the second catalyst layer for a longer period of time.

As illustrated in FIG. 4, the NOx-T50 showed a tendency to get higher (i.e., the NOx removal performance showed a tendency to get worse) as the second catalyst layer got longer, regardless of the particle size distribution of the initial Rh particles. However, the exhaust gas purification device using the Rh-containing catalyst produced by controlling the particle size distribution of the initial Rh particles by a heating under a nitrogen atmosphere showed a smaller increase in the NOx-T50 associated with the increase in the length of the second catalyst layer.

When the lengths of the second catalyst layers were the same, the exhaust gas purification device using the Rh-containing catalyst produced by performing the heating process under the nitrogen atmosphere showed the NOx-T50 lower than that of the exhaust gas purification device using the Rh-containing catalyst produced by not performing the heating process under the nitrogen atmosphere. The longer the second catalyst layer was, the more remarkable the NOx-T50 decrease due to the heating under the nitrogen atmosphere (that is, the NOx-T50 decrease due to the control of the particle size distribution of the initial Rh particles) was. For example, when the length of the second catalyst layer was 20% of the total length of the substrate, that is, the first catalyst layer did not substantially overlap with the second catalyst layer, the decrease in the NOx-T50 caused by the control of the particle size distribution of the initial Rh particles was only 2.0° C. On the other hand, when the length of the second catalyst layer was 80% of the total length of the substrate, that is, the length of the region where the first catalyst layer overlaps with the second catalyst layer was 60% of the total length of the substrate, the decrease in the NOx-T50 caused by the control of the particle size distribution of the initial Rh particles was as much as 17.2° C. The result shows that the increase in the mean of the particle size distribution of the initial Rh particles from 0.7 nm to 5.49 nm reduced the deterioration in NOx removal performance caused by the overlap of the first catalyst layer with the second catalyst layer.

Additionally, in Example 2 in which the second catalyst layer contained the barium sulfate and Example 4 in which the second catalyst layer did not contain the barium sulfate, NOx-T50s were equivalent.

TABLE 1

| | | Standard | | Average | Average | | |
|---|---|---|---|---|---|---|---|
| | Mean of | Deviation of | | Particle Size of | Particle Size of | | |
| | Particle Size | Particle Size | Length of | Rh Particles in | Rh Particles in | | OSC |
| | Distribution | Distribution | Second | First Catalyst | Second Catalyst | NOx- | Perfor- |
| | of Initial Rh | of Initial Rh | Catalyst | Layer after | Layer after | T50 | mance |
| | Particles [nm] | Particles [nm] | Layer [%] | Aging [nm] | Aging [nm] | [° C.] | [g] |
| Example 1 | 5.49 | 1.49 | 80 | | 7.26 | 295.7 | 0.287 |
| Example 2 | 5.49 | 1.49 | 55 | | 6.54 | 295.6 | 0.281 |
| Example 3 | 5.49 | 1.49 | 35 | 10.31 | 6.02 | 292.5 | 0.240 |
| Comparative | 5.49 | 1.49 | 20 | | | 290.1 | 0.220 |
| Example 1 | | | | | | | |
| Comparative | 0.70 | 0.23 | 80 | | 13.11 | 314.7 | 0.290 |
| Example 2 | | | | | | | |
| Comparative | 0.70 | 0.23 | 55 | | 11.25 | 305.1 | 0.276 |
| Example 3 | | | | | | | |
| Comparative | 0.70 | 0.23 | 35 | 6.75 | 9.88 | 295.4 | 0.235 |
| Example 4 | | | | | | | |
| Comparative | 0.70 | 0.23 | 20 | | | 292.1 | 0.222 |
| Example 5 | | | | | | | |
| Example 4 | 5.49 | 1.49 | 55 | | | 295.5 | 0.242 |

What is claimed is:

1. An exhaust gas purification device comprising:
a substrate including an upstream end through which an exhaust gas is introduced into the device and a downstream end through which the exhaust gas is discharged from the device, the substrate having a length (Ls) between the upstream end and the downstream end;
a first catalyst layer containing a rhodium-containing catalyst containing a metal oxide carrier and rhodium particles supported on the metal oxide carrier, the first catalyst layer extending across a first region, the first region extending between the downstream end and a first position, the first position being at a first distance (La) from the downstream end toward the upstream end; and
a second catalyst layer containing palladium particles and a material having a basicity higher than a basicity of the metal oxide carrier, the second catalyst layer extending across a second region, the second region extending between the upstream end and a second position, the second position being at a second distance (Lb) from the upstream end toward the downstream end,
wherein the length (Ls), the first distance (La), and the second distance (Lb) meet Ls<La+Lb, and
wherein a mean of a particle size distribution of the rhodium particles is from 1.5 nm to 18 nm.

2. The exhaust gas purification device according to claim 1,
wherein a standard deviation of the particle size distribution of the rhodium particles is less than 1.6 nm.

3. The exhaust gas purification device according to claim 1,
wherein the mean of the particle size distribution of the rhodium particles is more than 4 nm and equal to or less than 14 nm.

4. The exhaust gas purification device according to claim 1,
wherein the rhodium-containing catalyst contains the rhodium particles in an amount of 0.01 wt % to 3.0 wt % based on a total weight of the metal oxide carrier and the rhodium particles.

5. The exhaust gas purification device according to claim 1,
wherein the material having the basicity higher than the basicity of the metal oxide carrier is a barium compound.

6. The exhaust gas purification device according to claim 1,
wherein the length (Ls), the first distance (La), and the second distance (Lb) meet 1.1 Ls≤La+Lb≤1.8 Ls.

7. The exhaust gas purification device according to claim 1,
wherein the length (Ls), the first distance (La), and the second distance (Lb) meet 1.3 Ls≤La+Lb≤1.8 Ls.

8. The exhaust gas purification device according to claim 1,
wherein the metal oxide carrier is a composite oxide containing alumina and zirconia as main components.

9. A method for manufacturing the exhaust gas purification device according to claim 1, the method comprising:
preparing the rhodium-containing catalyst containing the metal oxide carrier and the rhodium particles supported on the metal oxide carrier, wherein the mean of the particle size distribution of the rhodium particles is from 1.5 nm to 18 nm;
forming the first catalyst layer containing the rhodium-containing catalyst in the first region extending between the downstream end of the substrate and the first position, the first position being at the first distance (La) from the downstream end toward the upstream end; and
forming the second catalyst layer containing the palladium particles and the material having the basicity higher than the basicity of the metal oxide carrier in the second region extending between the upstream end of the substrate and the second position, the second position being at the second distance (Lb) from the upstream end toward the downstream end.

10. The method according to claim 9,
wherein the preparing the rhodium-containing catalyst includes the steps, in this order, of:
impregnating the metal oxide carrier with a rhodium compound solution;
drying the metal oxide carrier impregnated with the rhodium compound solution; and
heating the dried metal oxide carrier to a temperature within a range from 700° C. to 900° C. under an inert atmosphere to obtain the rhodium-containing catalyst.

11. The method according to claim 10,
wherein the inert atmosphere is a nitrogen atmosphere.
